(19) United States
(12) Patent Application Publication
(10) Pub. No.: US 2001/0014297 A1
(43) Pub. Date: Aug. 16, 2001

(54) Method and device for the elimination of nitrogen oxides from an exhaust gas

(76) Inventor: Ronald Neufert, Michelau (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/776,946

(22) Filed: Feb. 5, 2001

Related U.S. Application Data
(63) Continuation of application No. PCT/DE99/02286, filed on Jul. 26, 1999.

(30) Foreign Application Priority Data
Aug. 3, 1998 (DE) 198 34 993.9

(51) Int. Cl. B01D 53/56; B01D 53/86; B01D 53/94

(52) U.S. Cl. 422/177; 422/170; 422/171; 422/172

(57) ABSTRACT

An exhaust gas laden with nitrogen oxides is subjected to a catalytic oxidation in an oxidizing catalyst. The exhaust gas is subsequently brought into contact with water and oxygen or air in a mixing device. This results in an exhaust gas freed of nitrogen oxides and in an aqueous solution. In a reaction vessel, the aqueous solution is reacted with a nitrogen-containing reducing agent, in particular with urea ((HN₂)₂CO), in an acidic aqueous medium under reducing conditions. The gas occurring at the same time is discharged through a discharge line.

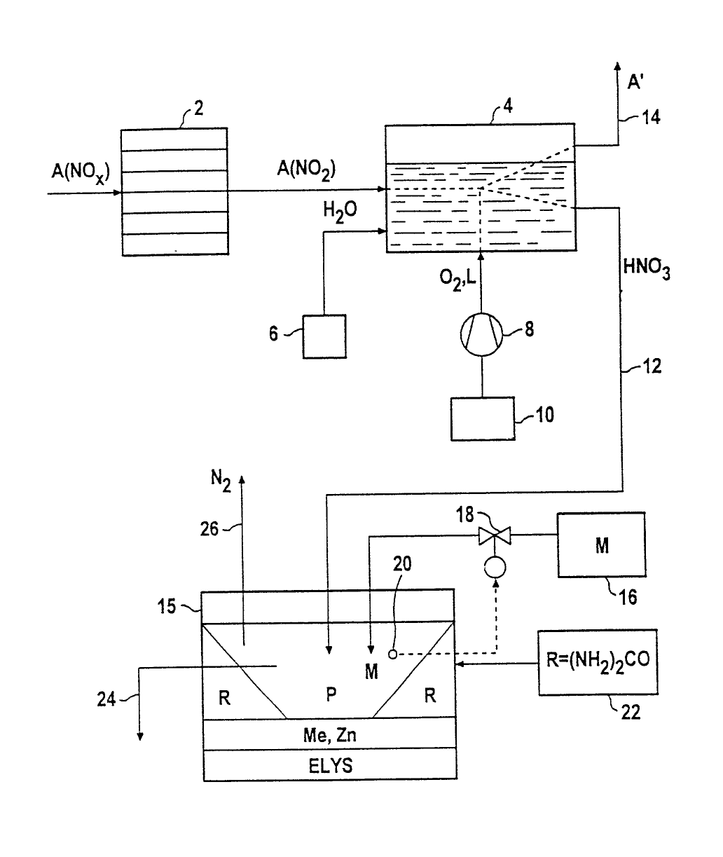

### CROSS-REFERENCE TO RELATED APPLICATION

This application is a continuation of copending International Application No. PCT/DE99/02286, filed Jul. 26, 1999, which designated the United States.

### BACKGROUND OF THE INVENTION

1. Field of the Invention

The invention relates to a method for the elimination of nitrogen oxides from an exhaust gas. It also relates to a device for the elimination of nitrogen oxides from the exhaust gas.

It is important, in the case of exhaust gases from combustion systems, for example from power stations or internal combustion engines, to reduce the nitrogen oxides (NOₓ) contained in them. For the purpose of nitrogen oxide reduction, nitrogen oxide reduction catalysts according to the selective catalytic reduction method with nitrogen-containing reducing agents are predominantly used nowadays. The reducing agents that may be considered here are ammonia (NH₃) or urea. In devices for nitrogen oxide reduction, the reducing agent is injected into the exhaust gas. In order to avoid slippage of the reducing agent, particularly in the case of ammonia that has an intense odor and is environmentally harmful, it is necessary to have a complicated metering-quantity control or regulation which is cost-intensive.

### SUMMARY OF THE INVENTION

It is accordingly an object of the invention to provide a method and a device for the elimination of nitrogen oxides from an exhaust gas which overcome the above-mentioned disadvantages of the prior art methods and devices of this general type, in which slippage of the reducing agent is ruled out.

With the foregoing and other objects in view there is provided, in accordance with the invention, a method for eliminating nitrogen oxides (NOₓ) from an exhaust gas. The method includes the steps of:

subjecting the exhaust gas to a catalytic oxidation process;

subsequently bringing the exhaust gas into contact with water (H₂O) and oxygen (O₂), resulting in a modified exhaust gas freed of the nitrogen oxides (NOₓ) and being in an aqueous solution;

reacting the aqueous solution with a nitrogen-containing reducing agent in an acidic aqueous medium under one of reducing conditions and reducing electrolysis conditions, resulting in a reaction solution and a gas being obtained; and

discharging the gas.

Obviously, in this method, slippage of the reducing agent is ruled out. The method is self-regulating, and there is no need for any reducing agent metering-quantity control or regulation.

According to an advantageous development, the exhaust gas is brought into contact with water and oxygen by the exhaust gas being led through the water, with air being injected at the same time. The purpose is served by the mixing device, in particular a gas scrubber, to which water and air are delivered.

In the present case, the acidic aqueous medium used is an acid which is fed to the reaction solution as a function of the pH value. In this case, the acid can be extracted from a reservoir, for example, in the case of a vehicle, the vehicle battery that is present in any case.

The nitrogen-containing reducing agent used here is preferably urea.

The reducing conditions can be afforded by the addition of a base metal, for example of zinc. The reducing electrolysis conditions can be afforded by electrochemical cathodic reduction with the aid of an electrolysis device.

In accordance with an added mode of the invention, there is the step of leading the exhaust gas through an oxidizing catalyst during the catalytic oxidation process.

In accordance with an additional mode of the invention, there is the step of forming the oxidizing catalyst with a substrate formed from aluminum oxide (Al₂O₃) or titanium oxide (TiO₂), and a layer is deposited on the substrate, and the layer is formed from platinum or palladium.

In accordance with another mode of the invention, there is the step of bringing the exhaust gas into contact with the water (H₂O) and the oxygen (O₂) by the exhaust gas being led through the water (H₂O), with air being injected at a same time.

In accordance with a further mode of the invention, there is the step of leading the exhaust gas through a gas scrubber, to which the water (H₂O) and the air can be delivered.

In accordance with another added mode of the invention, there is the step of discharging the exhaust gas after being brought into contact with the water (H₂O) and the oxygen (O₂).

In accordance with another additional mode of the invention, there is the step of forming the acidic aqueous medium as an acid and feeding the acid to the reaction solution in dependence on a pH value of the reaction solution.

In accordance with a further added mode of the invention, there is the step of extracting the acid from a reservoir.

In accordance with a further additional mode of the invention, there is the step of using urea as the nitrogen-containing reducing agent.

In accordance with an added mode of the invention, the reducing conditions are afforded by an addition of a base metal, including zinc.

In accordance with an additional mode of the invention, the reducing electrolysis conditions are afforded by electrochemical cathodic reduction with an aid of an electrolysis device.

In accordance with another mode of the invention, there is the step of supplying the aqueous solution to a reaction vessel, and delivering the nitrogen-containing reducing agent in one of a solid form and a dissolved form from a refilling device to the reaction vessel.

In accordance with a further mode of the invention, there is the step of introducing the nitrogen-containing reducing agent in excess into the aqueous solution.

In accordance with yet another mode of the invention, there is the step of filling up the refilling device with the reducing agent at predetermined time intervals.

In accordance with yet another additional mode of the invention, the reservoir is a vehicle battery.

With the foregoing and other objects in view there is also provided, in accordance with the invention, a device for eliminating nitrogen oxides (NOₓ) from an exhaust gas. The device contains an oxidizing catalyst for receiving the exhaust gas and a mixing device disposed downstream of the oxidizing catalyst. The mixing device receives the exhaust gas from the oxidizing catalyst and brings the exhaust gas into contact with water (H₂O) and oxygen (O₂) resulting in an aqueous solution. A reaction vessel is provided and a connecting line connects the mixing device to the reaction vessel. Through the connecting line the aqueous solution occurring in the mixing device can be supplied to the reaction vessel. In addition, the reaction vessel receives an acidic aqueous medium and a reducing agent containing nitrogen oxide and can be brought under reducing conditions or reducing electrolysis conditions.

In accordance with an additional feature of the invention, a water supply is connected to the mixing device and an oxygen source is connected to the mixing device.

In accordance with another feature of the invention, the mixing device contains a discharge line for discharging purified exhaust gas.

In accordance with a further feature of the invention, a reservoir for storing an acid is provided, and the reaction vessel is connected to the reservoir storing the acid.

In accordance with still another feature of the invention, a refilling device for storing the reducing agent in a solid form or a dissolved form is provided, and the reaction vessel is connected to the refilling device.

In accordance with another further feature of the invention, a pH-value sensor is disposed in the reaction vessel for measuring a pH value of the reaction solution in the reaction vessel, and an acid outflow from the reservoir can be controlled in dependence on the pH-value.

In accordance with an added feature of the invention, the reservoir storing the acid is a vehicle battery.

In accordance with an additional feature of the invention, the mixing device is a gas scrubber.

In accordance with a concomitant feature of the invention, the reducing agent stored in the refilling devices is urea (NH₂)₂CO).

Other features which are considered as characteristic for the invention are set forth in the appended claims.

Although the invention is illustrated and described herein as embodied in a method and a device for the elimination of nitrogen oxides from an exhaust gas, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The single FIGURE of the drawing is a block diagram of a device for eliminating nitrogen oxides from an exhaust gas according to the invention.

### DESCRIPTION OF THE PREFERRED EMBODIMENTS

Referring now to the single FIGURE of the drawing in detail, there is shown a device for eliminating nitrogen oxides NOₓ from an exhaust gas A. The exhaust gas A laden with the nitrogen oxides NOₓ is supplied to an oxidizing catalyst 2. This may be a noble-metal catalyst 2 which possesses, for example, a layer of platinum or palladium on a substrate of aluminum oxide (Al₂O₃) or titanium oxide (TiO₂). In the oxidizing catalyst 2, the NOₓ is oxidized quantitatively to NO₂. The exhaust gas A is then supplied to a mixing device 4. This may be, for example, a gas scrubber or a similar device. The exhaust gas A laden with NO₂ is led through water H₂O here, with air L or oxygen O₂ being injected at the same time. The mixing device 4 is connected to a water supply 6 for supplying water. By a blower 8, oxygen O₂, particularly in the form of air L, is supplied to the mixing device 4 from an oxygen source 10. In the mixing device 4, the NO₂ is converted into nitric acid according to the reaction

4NO₂+2H₂O+O₂→4HNO₃,

if appropriate with a non-illustrated catalyst being used to assist. Without air L being injected, a mixture of nitrous acid and nitric acid is obtained. The nitric acid (HNO₃ in an aqueous solution) is drawn off via a connecting line 12. The exhaust gas A′ freed of the nitrogen oxide NO₂ is discharged via a discharge line 14.

The HNO₃ in aqueous solution is delivered via the connecting line 12 to a reaction vessel 15. Here, conversion takes place in an acidic medium M with a nitrogen-containing reducing agent R, preferably urea (NH₂)₂CO, under reducing conditions, for example by a base metal Me, such as zinc Zn, or under reducing electrolysis conditions (cathodic reduction), this being designated by ELYS. In this case, elementary nitrogen N₂ is formed from nitrate NO₃ quantitatively with the urea according to the short formula

NO₃⁻+(NH₂)₂CO→N₂+H₂O.

Nitrogen NO₂ is formed from nitrite NO₂ in an acidic medium M with urea even without reducing conditions.

The acidic medium M, in particular an acid, such as sulfuric acid, which, in the case of a motor vehicle, can be extracted from the vehicle battery, is retrieved, as required, from a reservoir 16. The controlled supply of the acid takes place via a control valve 18 that is activated by a pH-value sensor 20. The pH-value sensor 20 measures a pH value of the reaction solution P, for example by use of a glass electrode. When the reaction solution P leaves the acidic range, acid is delivered from the reservoir 16 via the valve 18.

A refilling device 22, which is connected to the reaction vessel 15, is provided for the nitrogen-containing reducing agent R, that is say, for example, urea (NH₂)₂CO.

The reducing agent R may be introduced in excess into the reaction vessel 15 in a solid or dissolved form. This is because, in each case, only as much is consumed as there are nitrate/nitrite ions present in the reaction vessel 15. Ideally, the quantity may be dimensioned, if appropriate by automatic refilling from the refilling device 22 or from a supply cartridge, in such a way that the supply can be filled up within the framework of a regulating service. Such a regulating service may be carried out in a regular inspection, during a predetermined stay in a workshop, when a chimney sweep is visiting, etc.

Water and other substances of the reaction solution P can be extracted from the reaction vessel 15 through a discharge line 24. And nitrogen N₂ can be extracted through a discharge line 26.

It should be noted, once again, that, in the exemplary embodiment shown in the FIGURE, a self-regulating method takes place, in which there is no need to control the metering quantity of the reducing agent R. Slippage of the reducing agent R during the elimination of nitrogen oxides therefore cannot occur.

I claim:

1. A method for eliminating nitrogen oxides (NOₓ) from an exhaust gas, which comprises the steps of:
subjecting the exhaust gas to a catalytic oxidation process;
subsequently bringing the exhaust gas into contact with water (H₂O) and oxygen (O₂), resulting in a modified exhaust gas freed of the nitrogen oxides (NOₓ) and being in an aqueous solution;
reacting the aqueous solution with a nitrogen-containing reducing agent in an acidic aqueous medium under one of reducing conditions and reducing electrolysis conditions, resulting in a reaction solution and a gas being obtained; and
discharging the gas.

2. The method according to claim 1, which comprises leading the exhaust gas through an oxidizing catalyst during the catalytic oxidation process.

3. The method according to claim 2, which comprises forming the oxidizing catalyst with a substrate formed of a material selected from the group consisting of aluminum oxide (Al₂O₃) and titanium oxide (TiO₂), and a layer deposited on the substrate, and the layer is formed from a material selected from the group consisting of platinum and palladium.

4. The method according to claim 1, which comprises bringing the exhaust gas into contact with the water (H₂O) and the oxygen (O₂) by the exhaust gas being led through the water (H₂O), with air being injected at a same time.

5. The method according to claim 4, which comprises leading the exhaust gas through a gas scrubber, to which the water (H₂O) and the air can be delivered.

6. The method according to claim 1, which comprises discharging the exhaust gas after being brought into contact with the water (H₂O) and the oxygen (O₂).

7. The method according to claim 1, which comprises forming the acidic aqueous medium as an acid and feeding the acid to the reaction solution in dependence on a pH value of the reaction solution.

8. The method according to claim 7, which comprises extracting the acid from a reservoir.

9. The method according to claim 1, which comprises using urea as the nitrogen-containing reducing agent.

10. The method according to claim 1, wherein the reducing conditions are afforded by an addition of a base metal, including zinc.

11. The method according to claim 1, wherein the reducing electrolysis conditions are afforded by electrochemical cathodic reduction with an aid of an electrolysis device.

12. The method according to claim 1, which comprises supplying the aqueous solution to a reaction vessel, and delivering the nitrogen-containing reducing agent in one of a solid form and a dissolved form from a refilling device to the reaction vessel.

13. The method according to claim 1, which comprises introducing the nitrogen-containing reducing agent in excess into the aqueous solution.

14. The method according to claim 12, which comprises filling up the refilling device with the reducing agent at predetermined time intervals.

15. The method according to claim 8, wherein the reservoir is a vehicle battery.

16. A device for eliminating nitrogen oxides (NOₓ) from an exhaust gas, comprising:
an oxidizing catalyst for receiving the exhaust gas;
a mixing device disposed downstream of said oxidizing catalyst, said mixing device receives the exhaust gas from said oxidizing catalyst and brings the exhaust gas into contact with water (H₂O) and oxygen (O₂) resulting in an aqueous solution;
a reaction vessel; and
a connecting line connecting said mixing device to said reaction vessel and through said connecting line the aqueous solution occurring in said mixing device can be supplied to said reaction vessel, said reaction vessel receiving an acidic aqueous medium and a reducing agent containing nitrogen oxide and which can be brought under one of reducing conditions and reducing electrolysis conditions.

17. The device according to claim 16, wherein said oxidizing catalyst contains a substrate formed of a material selected from the group consisting of aluminum oxide (Al₂O₃) and titanium oxide (TiO₂), and a layer disposed on said substrate, said layer formed of a material selected from the group consisting of platinum and palladium.

18. The device according to claim 16, including:
a water supply connected to said mixing device; and
an oxygen source connected to said mixing device.

19. The device according to claim 16, wherein said mixing device contains a discharge line for discharging purified exhaust gas.

20. The device according to claim 16, including a reservoir for storing an acid, and said reaction vessel is connected to said reservoir storing the acid.

21. The device according to claim 16, including a refilling device for storing the reducing agent in one of a solid form and a dissolved form, and said reaction vessel connected to said refilling device.

22. The device according to claim 20, including a pH-value sensor disposed in said reaction vessel for measuring a pH value of the reaction solution in said reaction vessel, and an acid outflow from said reservoir can be controlled in dependence on the pH-value.

23. The device according to claim 20, wherein said reservoir storing the acid is a vehicle battery.

24. The device according to claim 16, wherein said mixing device is a gas scrubber.

25. The device according to claim 12, wherein the reducing agent stored in said refilling devices is urea ((NH₂)₂CO).
